(19) United States
(12) Patent Application Publication
(10) Pub. No.: US 2025/0193965 A1
(43) Pub. Date: Jun. 12, 2025

(54) METHODS FOR SUPPORTING ARBITRARY DRX CYCLE AND PERIODICITY OF SPS AND CG IN MOBILE COMMUNICATIONS

(71) Applicant: MediaTek Singapore Pte. Ltd., Singapore (SG)

(72) Inventors: Mehmet KUNT, Cambridge (GB); Pradeep JOSE, Cambridge (GB); Abdellatif SALAH, Cambridge (GB)

(21) Appl. No.: 18/844,912

(22) PCT Filed: May 23, 2022
(86) PCT No.: PCT/CN2023/091420

§ 371 Date: Sep. 6, 2024

Related U.S. Application Data
(60) Provisional application No. 63/344,651, filed on May 23, 2022.

(51) Int. Cl. H04W 76/28; H04W 72/11

(52) U.S. Cl. CPC H04W 76/28; H04W 72/11

(57) ABSTRACT

Techniques and solutions pertaining to supporting arbitrary discontinuous reception (DRX) cycle and periodicity of semi-persistent scheduling (SPS) and configured grant (CG) in mobile communications are described. An apparatus (e.g., user equipment (UE)) enters a DRX mode in wireless communications. The apparatus communicates with a network when in the DRX mode by using an extended system frame number (E-SFN) that wraps at a maximum value of the E-SFN and supports either or both of a non-integer DRX cycle and a non-integer periodicity of SPS/CG.

### CROSS REFERENCE TO RELATED PATENT APPLICATION(S)

The present disclosure is part of a non-provisional application claiming the priority benefit of U.S. Patent Application No. 63/344,651, filed 23 May 2022, the content of which herein being incorporated by reference in its entirety.

### TECHNICAL FIELD

The present disclosure is generally related to mobile communications and, more particularly, to techniques for supporting arbitrary discontinuous reception (DRX) cycle and semi-persistent scheduling (SPS) and configured grant (CG) periodicity in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), DRX cycle values in legacy DRX are a factor of 10240 (e.g., 10240/DRX cycle=N, with N being an integer). This design ensures that, when a system frame number (SFN) wraps (e.g., 1023→0), the DRX cycles would align with an end of a hyper frame (at 10240 ms). In the context of extended reality (XR), the frame rate (frames per second, or fps) for a media traffic can be, for example, 30 fps or 60 fps. On the other hand, it may be beneficial to align the DRX cycles with the traffic periodicity. This means that DRX cycles such as 100/3=33.33 ms or 50/3=16.67 ms may need to be defined. When DRX cycles are not factors of 10240, according to existing legacy DRX formulas, the DRX cycles would not align at the SFN wrap, at the end of the hyper frame (10240 ms).

In order to resolve the issue with the SFN wrapping using current DRX formulas, a new solution is necessary. Within a DRX operation, it is imperative that a user equipment (UE) and a network always share the same view of DRX cycles. It may be undesirable to rely on some counters or timers that are maintained independently on the UE and the network as a potential solution. It may be beneficial that the network informs the UE about the timeframes used for synchronization of DRX cycles as in legacy DRX operations (e.g., using SFN and subframe numbers that are broadcast by the network). Additionally, the DRX formulas with non-integer periodicities, such as 100/3 and 50/3, could be complicated and may involve floor or round operations. Therefore, there is a need for a solution of supporting arbitrary DRX cycle and SPS/CG periodicity in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving supporting arbitrary DRX cycle and SPS/CG periodicity in mobile communications. It is believed that, under the various proposed schemes, aforementioned issues may be avoided, reduced or otherwise alleviated.

In one aspect, a method may involve user equipment (UE) entering a DRX mode in wireless communications. The method may also involve the UE communicates with a network when in the DRX mode by using an extended system frame number (E-SFN) that wraps at a maximum value of the E-SFN and supports either or both of a non-integer DRX cycle and a non-integer periodicity of SPS/CG.

In another aspect, an apparatus implementable in a UE may include a transceiver configured to communicate wirelessly and a processor coupled to the transceiver. The processor may enter a DRX mode in wireless communications. The processor may also communicate with a network when in the DRX mode by using an E-SFN that wraps at a maximum value of the E-SFN and supports either or both of a non-integer DRX cycle and a non-integer periodicity of SPS/CG.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a block diagram of an example communication system in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to supporting arbitrary DRX cycle and SPS/CG periodicity in mobile communications. According to the present disclosure, a number of possible solutions may be implemented separately or jointly. That is, although these possible solutions may be described below separately, two or more of these possible solutions may be implemented in one combination or another.

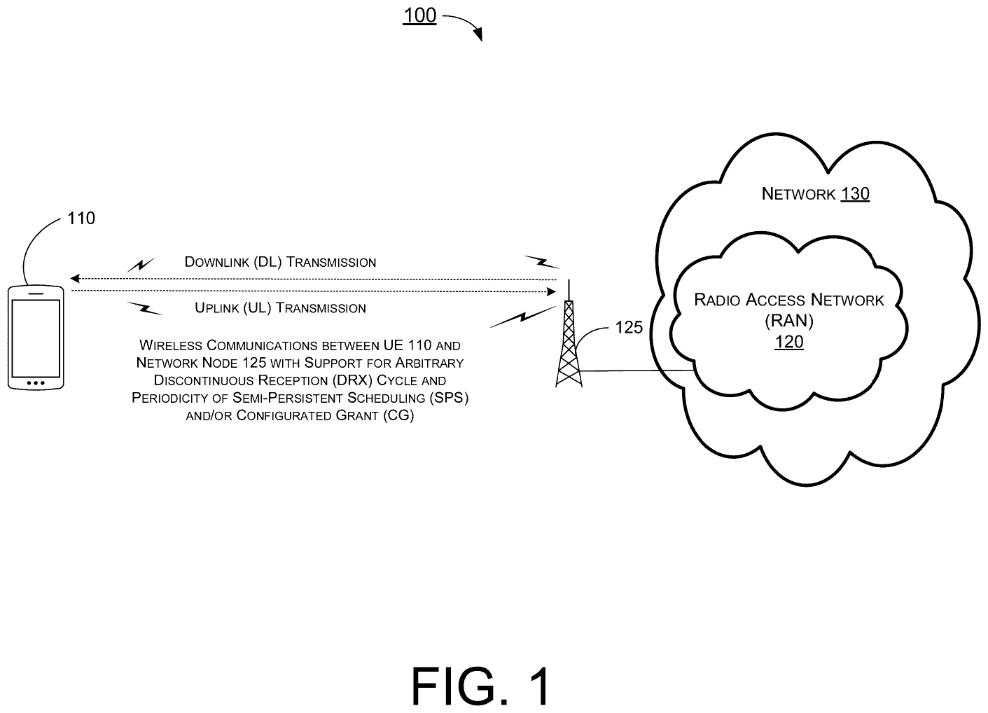

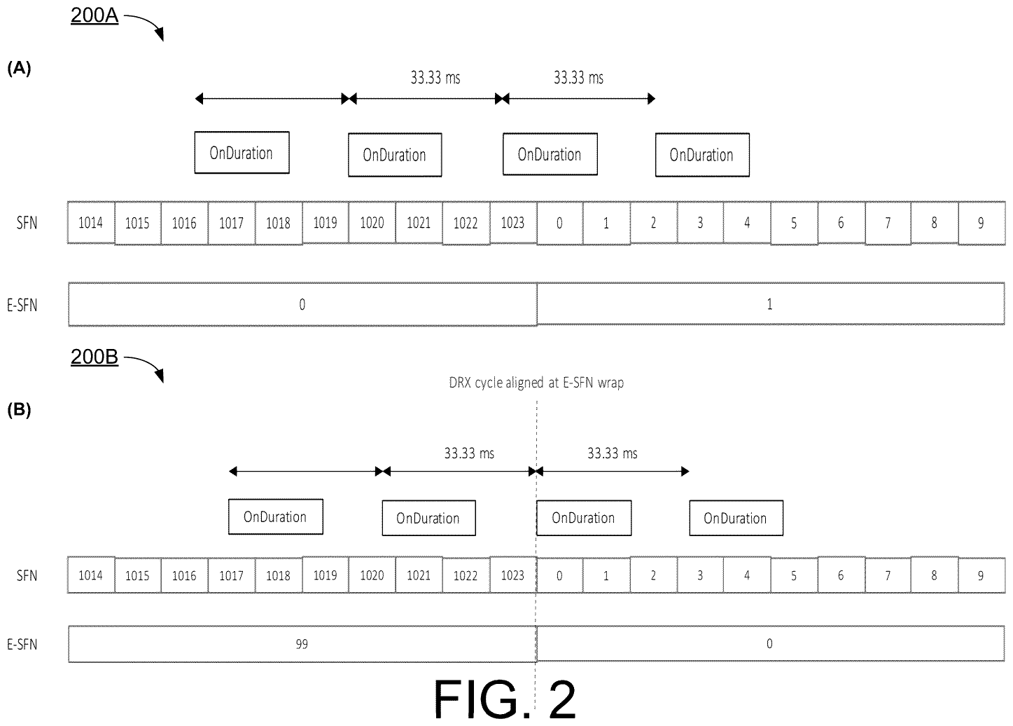

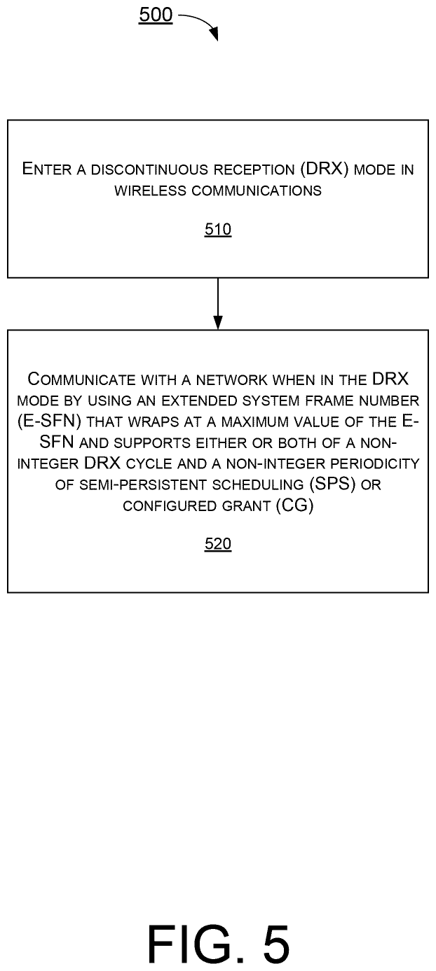

FIG. 1 illustrates an example network environment 100 in which various solutions and schemes in accordance with the present disclosure may be implemented. FIG. 2˜FIG. 5 illustrate examples of implementation of various proposed schemes in network environment 100 in accordance with the present disclosure. The following description of various proposed schemes is provided with reference to FIG. 1˜FIG. 5.

Referring to FIG. 1, network environment 100 may involve a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB or transmit-receive point (TRP)). RAN 120 may be a part of a network 130. In network environment 100, UE 110 and network 130 (via network node 125 of RAN 120) may implement various schemes pertaining to supporting arbitrary DRX cycle and SPS/CG periodicity in mobile communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Under a first proposed scheme in accordance with the present disclosure, a new reference frame number (herein interchangeably referred to as “extended-SFN” and “E-SFN”) may be introduced. Under the proposed scheme, the E-FSN may be broadcast by network 130 (e.g., via network node 125) in System Information (SI) (e.g., in system information block 1 (SIB1)). The value of E-SFN may be in a range of 0˜(maximum E-SFN value). The E-SFN may be incremented by 1 every time an existing SFN wraps (e.g., SFN: 1023→0, with the maximum value of the existing SFN being 1023). The E-SFN may wrap at a maximum E-SFN value. This maximum value of E-SFN may be different from the maximum value of the bit-field information element (IE) in the SI in which the E-SFN is transmitted. For instance, the bit-field may be 7 bits long and the E-SFN may wrap at 99→0. Alternatively, the bit-field may be 10 bits long and the E-SFN may wrap at 99→0 or 999→0. In some implementations, the absolute maximum size of the E-SFN (the size of the bit-field used in signaling) may be predefined (e.g., as 7 bits or 10 bits). In some implementations, the maximum value of the E-SFN (when E-SFN wraps) may be left for network 130 to decide. In some implementations, the maximum value of the E-SFN may be indicated to UE 110 via SI or a dedicated radio resource control (RRC) signaling. Alternatively, the maximum value of the E-SFN may be fixed in the 3GPP specification(s) or may be implicit from the bit size of the E-SFN field (e.g., for 7 bits, the maximum value=99).

Under the first proposed scheme, the E-SFN may be used in the DRX formulas to determine the subframe to start the drx-onDurationTimer (herein interchangeably referred to as “on-duration timer”, “OnDurationTimer” and “ODT”). Under the proposed scheme, network 130 may set the maximum value of the E-SFN such that a DRX cycle with a value that is not a factor of 10240 ms, such as 100 ms, may align at the wraparound of E-SFN. Moreover, UE 110 and/or network 130 may use the E-SFN formulas in case the E-SFN is broadcast by network 130, or when UE 110 is configured to use the E-SFN, or when UE 110 receives some indication in downlink control information (DCI), medium access control (MAC) control element (CE), SI and/or dedicated RRC signaling. Furthermore, UE 110 and/or network 130 may use the E-SFN and existing SFN-based formulas at the same time. For instance, for DRX configurations where the DRX cycle is not a factor of 10240, the E-SFN formulas may be used; otherwise, legacy formulas (without E-SFN) may be used for other configurations. Under the proposed scheme, the E-SFN may be used in SPS and/or CG formulas (e.g., to determine the timing of SPS and/or CG occasions). This may render it unnecessary for UE 110 and network 130 to independently count the number of frames since the activation of the SPS/CG, thereby improving the reliability of the SPS/CG operation. Moreover, the E-SFN may be used when special services, such as XR/CG, are activated.

Under the first proposed scheme, the DRX formula for determining the subframe where the ODT is started may be defined as follows:
If a short DRX cycle is used for a DRX group:

$$[ ( E - SFN \times 10240 ) + ( SFN \times 10 ) + subframe number ] modulo \text{} ( drx - ShortCycle ) = ( drx - StartOffset ) modulo ( drx - ShortCycle )$$

If a long DRX cycle is used for a DRX group:

$$[ ( E - SFN \times 10240 ) + ( SFN \times 10 ) + subframe number ] \text{} modulo ( drx - LongCycle ) = drx - StartOffset$$

FIG. 2 illustrates example scenarios under the first proposed scheme in accordance with the present disclosure. Part (A) of FIG. 2 shows a first example scenario 200A and part (B) of FIG. 2 shows a second example scenario 200B under the first proposed scheme. In scenario 200A, for E-SFN=(0, 1, . . . , 99) (e.g., maximum E-SFN=99), with DRX cycle=33.33 ms and ODT=20 ms, the DRX cycles at SFN wrap may look like what is shown in part (A) of FIG. 2. In scenario 200B, for E-SFN=(0, 1, . . . , 99) (e.g., maximum E-SFN=99), with DRX cycle=33.33 ms and ODT=20 ms, the DRX cycles at E-SFN wrap may look like what is shown in part (B) of FIG. 2.

Under a second proposed scheme in accordance with the present disclosure, legacy DRX formulas may be used, and a new DRX start offset based on E-SFN value (herein interchangeably referred to as “drx-StartOffset_E_SFN”) may be used. Under the proposed scheme, the value of drx_StartOffset_E_SFN may be determined based on the E-SFN value. The DRX formula for determining the subframe where the ODT is started may be defined as follows:
If a short DRX cycle is used for a DRX group:

$$[ ( E - SFN \times 10240 ) + ( SFN \times 10 ) + subframe number ] \text{} modulo ( drx - ShortCycle ) = ( drx - StartOffset\_E \_SFN ) modulo ( drx - ShortCycle )$$

If a long DRX cycle is used for a DRX group:

$$[ ( E - SFN \times 10240 ) + ( SFN \times 10 ) + subframe number ] \text{} modulo ( drx - ShortCycle ) = drx - StartOffset\_E \_SFN ,$$

where:

$$drx - StartOffset\_E \_SFN = [ drx - StartOffset + [ ( E - SFN \% N ) ⋆ Delta - Offset ) ] \% drx - StartCycle ( if Short DRX cycle is used )$$

$$drx - StartOffset\_E \_SFN = [ drx - StartOffset + [ ( E - SFN \% N ) ⋆ Delta - Offset ) ] \% drx - LongCycle ( if Long DRX cycle is used )$$

$$N = LCM ( drx - ShortCycle , Delta - Offset ) / Delta - \text{} Offset ( LCM - Least Common Multiple ) ( i f Short DRX cycle is used )$$

$$N = LCM ( drx - LongCycle , Delta - Offset ) / Delta - \text{} Offset ( LCM - Least Common Multiple ) ( if Long DRX cycle is used )$$

$$Delta - Offset = drx - ShortCycle - ( 10240 \% drx - ShortCycle ) ( if Short DRX cycle is used )$$

$$Delta - Offset = drx - LongCycle - ( 10240 \% drx - Long Cycle ) ( if Long DRX cycle is used )$$

Under a third proposed scheme in accordance with the present disclosure, the E-SFN may be counted independently on UE 110 and network 130. In such cases, there may be no need for network 130 to broadcast the E-SFN. The counter may be initialized via a dedicated RRC signaling (e.g., when DRX is configured and the maximum value may be indicated to UE 110 by network 130). Alternatively, UE 110 and network 130 may agree on the start time for the DRX cycle (e.g., without defining E-SFN). For instance, the start time of the DRX cycle may be based on when a RRC reconfiguration is received by UE 110, when a special MAC CE is received by UE 110, when a DCI is received by UE 110. Alternatively, the start time of the DRX cycle may be based on a configuration or an indication in a RRC/MAC CE/DCI signaling. Moreover, UE 110 and network 130 may start the ODT every DRX cycle thereafter.

Under a fourth proposed scheme in accordance with the present disclosure, the E-SFN may be indicated in a MAC CE or DCI, with a special MAC CE or DCI format, or using unused bits in an existing DCI format. Under the proposed scheme, network 130 may inform UE 110 about the current E-SFN value using a MAC CE or DCI. For instance, network 130 may send an E-SFN in DCI for the last or first packet for a media frame (e.g., I-frame or P-frame). This proposed scheme may be utilized to synchronize the E-SFN value in UE 110 and network 130.

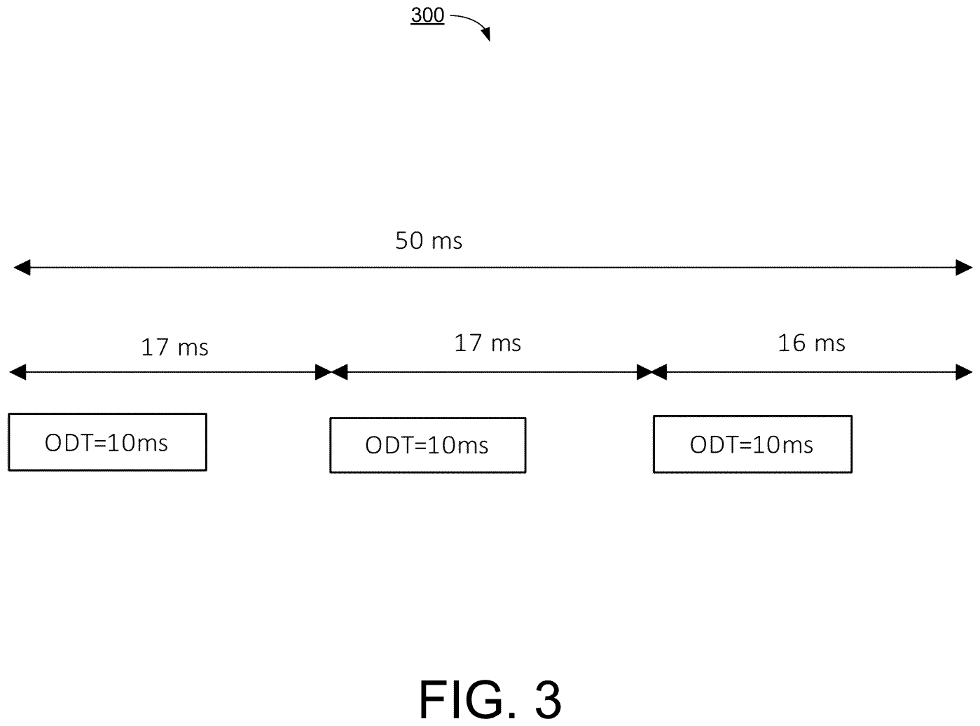

Under a fifth proposed scheme in accordance with the present disclosure, to resolve the issue with complicated formulas with non-integer DRX cycles and/or periodicities, OnDuration grouping configuration with integer values may be used to approximate the DRX cycles. Under the proposed scheme, OnDuration groups may be configured such that, when a physical downlink control channel (PDCCH) indicating a new downlink (DL) or uplink (UL) transmission is received, the other OnDuration occasions within a current OnDuration group may not be skipped. FIG. 3 illustrates an example scenario 300 under the fifth proposed scheme in accordance with the present disclosure. Referring to FIG. 3, for a DRX cycle=50/3=16.67 ms, a group with DRX cycle=50 ms may be defined. Moreover, occasions within the group may be defined, such as ODT₀=10, GAP₀=7, ODT₁=10, GAP₁=7, ODT₂=10, GAP₂=6. This may emulate three DRX cycles (17, 17, 16) with ODT=10.

Under a sixth proposed scheme in accordance with the present disclosure, as an alternative solution for non-integer DRX cycles, the formula for determining the subframe where the ODT is started may be defined as follows:
If a short DRX cycle is used for a DRX group:

$$floor \{ n - [ d r x - ShortCycle \times floor ( n / drx - ShortCycle ) ] \} = \text{} floor \{ drx - StartOffset - [ drx - ShortCycle \times \text{} floor ( \text{} drx - StartOffset / drx - ShortCycle ) ] \}$$

If a long DRX cycle is used for a DRX group:

$$floor \{ n - [ drx - LongCycle \times floor ( n / drx - LongCycle ] \} = \{ drx - StartOffset$$

$$n = ( E - SFN \times 10240 ) + ( SFN \times 10 ) + subframe number$$

alternatively, n=(SFN×10)+subframe number

Under the proposed scheme, the modulo operation (mod) may be replaced by the following function in the legacy DRX formulas:

$$A mod B = A - [ B \times floor ( A / B ) ]$$

Advantageously, this design may ensure that the new DRX formulas with non-integer parameters (such as drx-ShortCycle and drx-LongCycle) may function in all hardware and software platforms and implementations, including those that do not support non-integer parameters as input to the modulo function.

Under a seventh proposed scheme in accordance with the present disclosure, a two-step procedure to find the subframe where the ODT is started may be defined. In a first step of the procedure, for a coarse cycle, “coarse DRX cycle” may be defined with a group of DRX cycles. The coarse DRX cycle (coarse_drx-LongCycle or coarse_drx-ShortCycle) may be the smallest integer cycle such that:

$$coarse\_drx - LongCycle = n ⋆ drx - LongCycle , or$$

$$coarse\_drx - ShortCycle = n ⋆ drx - ShortCycle$$

In some implementations, the integer n may be found (as the numerator) by reducing the frame rate into an irreducible fraction. For instance,

$$60 fps = \frac{60}{1000} = \frac{3}{50} \to n = 3 .$$

In some implementations, the coarse DRX cycle may be found (as the denominator) by reducing the frame rate into an irreducible fraction. For instance,

$$60 fps = \frac{60}{1000} = \frac{3}{50} \to coarse DRX cycle = 50.$$

The legacy formulas may be utilized with the coarse cycle as follows:
If a short DRX cycle is used for a DRX group:

$$[ ( SFN \times 10 ) + subframe number ] modulo ( coarse\_drx - ShortCycle ) = ( coarse\_drx - StartOffset ) modulo ( coarse\_drx - ShortCycle )$$

If a long DRX cycle is used for a DRX group:

$$[ ( SFN \times 10 ) + subframe number ] modulo ( coarse\_drx - LongCycle ) = coarse\_drx - StartOffset )$$

In a second step of the procedure, exact start within the DRX group may be as follows:
If a short DRX cycle is used for a DRX group:

$$floor \{ coarse\_drx - StartOffset - [ drx - \text{} ShortCycle \times \text{} floor ( coarse\_drxStartOffset / drx - ShortCycle ) ] \} = \text{} floor \{ drx - StartOffset - [ drx - ShortCycle \times \text{} floor ( drx - StartOffset / drx - ShortCycle ) ] \}$$

If a long DRX cycle is used for a DRX group:

$$floor \{ coarse\_drx - StartOffset - [ drx - LongCycle \times floor ( coarse\_drxStartOffset / drx - LongCycle ) ] \} = drx - StartOffset$$

### Illustrative Implementations

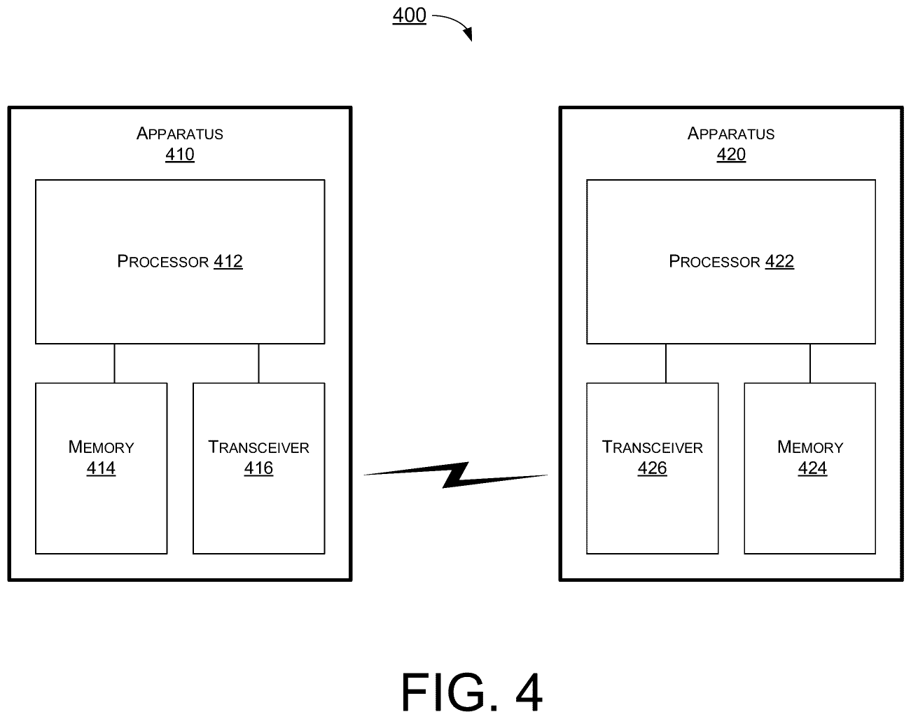

FIG. 4 illustrates an example communication system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to supporting arbitrary DRX cycle and SPS/CG periodicity in mobile communications, including the various schemes described above with respect to various proposed designs, concepts, schemes, systems and methods described above, including network environment 100, as well as processes described below.

Each of apparatus 410 and apparatus 420 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 410 and apparatus 420 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 410 and apparatus 420 may be implemented in a smart thermostat, a smart fridge, a smart door lock, a wireless speaker or a home control center. When implemented in or as a network apparatus, apparatus 410 and/or apparatus 420 may be implemented in an eNodeB in an LTE, LTE-Advanced or LTE-Advanced Pro network or in a gNB or TRP in a 5G network, an NR network or an IoT network.

In some implementations, each of apparatus 410 and apparatus 420 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 410 and apparatus 420 may be implemented in or as a network apparatus or a UE. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC or RISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to supporting arbitrary DRX cycle and SPS/CG periodicity in mobile communications in accordance with various implementations of the present disclosure.

In some implementations, apparatus 410 may also include a transceiver 416 coupled to processor 412. Transceiver 416 may be capable of wirelessly transmitting and receiving data. In some implementations, transceiver 416 may be capable of wirelessly communicating with different types of wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs/wireless networks of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410, as a UE (e.g., UE 110), and apparatus 420, as a network node (e.g., network node 125 or another network node implementing one or more network-side functionalities described above) of an application server side network (e.g., network 130 as a 5G/NR mobile network), is provided below.

Under various proposed schemes in accordance with the present disclosure pertaining to supporting arbitrary DRX cycle and SPS/CG periodicity in mobile communications, processor 412 of apparatus 410, implemented in or as a UE (e.g., UE 110) may enter a DRX mode in wireless communications. Moreover, processor 412 may communicate, via transceiver 416, with a network (e.g., with network 130 via apparatus 420 as network node 125) by using an E-SFN that wraps at a maximum value of the E-SFN and supports either or both of a non-integer DRX cycle and a non-integer periodicity of SPS/CG.

In some implementations, in communicating, processor 412 may receive a value of the E-SFN in a SIB broadcast by the network.

In some implementations, in communicating, processor 412 may determine a subframe where a DRX ODT is started based on a DRX formula defined as:
if a short DRX cycle is used for a DRX group:

$$floor \{ n - [ ShortCycle \times floor ( n / drx - ShortCycle ) ] \} = \text{} floor \{ drx - StartOffset - [ drx - \text{} ShortCycle \times \text{} floor ( drx - StartOffset / drx - ShortCycle ) ] \} ,$$

if a long DRX cycle is used for a DRX group:

$$floor \{ n - [ drx - LongCycle \times floor ( n / drx - LongCycle ) ] \} = drx - StartOffset ,$$

In the above DRX formulate, n=(E-SFN×10240)+(SFN×10)+subframe number or n=(SFN×10)+subframe number. Additionally, drx-ShortCycle may denote the short DRX cycle, drx-LongCycle may denote the long DRX cycle, drx-StartOffset may denote a DRX start offset, and SFN may denote an existing system frame number. In some implementations, in communicating, processor 412 may communicate using the DRX formula with respect to a subset of DRX configurations. For instance, the subset of DRX configurations may include one or more DRX configurations in which a DRX cycle is not a factor of 10240 milliseconds. In some implementations, the E-SFN may be incremented by 1 every time the SFN wraps at a maximum value of the SFN.

Alternatively, in communicating, processor 412 may determine a subframe where a DRX ODT is started based on a DRX formula defined as:
if a short DRX cycle is used for a DRX group:

$$[ ( E - SFN \times 10240 ) + ( SFN \times 10 ) + subframe number ] modulo ( drx - ShortCycle ) = ( drx - StartOffset ) modulo ( drx - ShortCycle ) ,$$

if a long DRX cycle is used for a DRX group:

$$[ ( E - SFN \times 10240 ) + ( SFN \times 10 ) + subframe number ] modulo ( drx - ShortCycle ) = drx - StartOffset ,$$

In the above DRX formulate, drx-ShortCycle may denote the short DRX cycle, drx-LongCycle may denote the long DRX cycle, drx-StartOffset may denote a DRX start offset, and SFN may denote an existing system frame number. In some implementations, in communicating, processor 412 may communicate using the DRX formula with respect to a subset of DRX configurations. For instance, the subset of DRX configurations may include one or more DRX configurations in which a DRX cycle is not a factor of 10240 milliseconds. In some implementations, the E-SFN may be incremented by 1 every time the SFN wraps at a maximum value of the SFN.

### Illustrative Processes

FIG. 5 illustrates an example process 500 in accordance with an implementation of the present disclosure. Process 500 may represent an aspect of implementing various proposed designs, concepts, schemes, systems and methods described above, whether partially or entirely, including those pertaining to those described above. More specifically, process 500 may represent an aspect of the proposed concepts and schemes pertaining to supporting arbitrary DRX cycle and SPS/CG periodicity in mobile communications. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 410 and apparatus 420 as well as any variations thereof. Solely for illustrative purposes and without limiting the scope, process 500 is described below in the context of apparatus 410 as a UE (e.g., UE 110) and apparatus 420 as a communication entity such as a network node or base station (e.g., network node 125 or another network node implementing one or more network-side functionalities described above) of an application server side network (e.g., network 130). Process 500 may begin at block 510.

At 510, process 500 may involve processor 412 of apparatus 410, implemented in or as a UE (e.g., UE 110) entering a DRX mode in wireless communications. Process 500 may proceed from 510 to 520.

At 520, process 500 may involve processor 412 communicating, via transceiver 416, with a network (e.g., with network 130 via apparatus 420 as network node 125) by using an E-SFN that wraps at a maximum value of the E-SFN and supports either or both of a non-integer DRX cycle and a non-integer periodicity of SPS/CG.

In some implementations, in communicating, process 500 may involve processor 412 receiving a value of the E-SFN in a SIB broadcast by the network.

In some implementations, in communicating, process 500 may involve processor 412 determining a subframe where a DRX ODT is started based on a DRX formula defined as:
if a short DRX cycle is used for a DRX group:

$$floor \{ n - [ drx - ShortCycle \times floor ( n / drx - ShortCycle ) ] \} = floor \{ drx - StartOffset - [ drx - ShortCycle \times floor ( drx - StartOffset / drx - ShortCycle ) ] \} ,$$

if a long DRX cycle is used for a DRX group:

$$floor \{ n - [ drx - LongCycle \times floor ( n / drx - LongCycle ) ] \} = drx - StartOffset ,$$

In the above DRX formulate, n=(E-SFN×10240)+(SFN×10)+subframe number or n=(SFN×10)+subframe number. Additionally, drx-ShortCycle may denote the short DRX cycle, drx-LongCycle may denote the long DRX cycle, drx-StartOffset may denote a DRX start offset, and SFN may denote an existing system frame number. In some implementations, in communicating, process 500 may further involve processor 412 communicating using the DRX formula with respect to a subset of DRX configurations. For instance, the subset of DRX configurations may include one or more DRX configurations in which a DRX cycle is not a factor of 10240 milliseconds. In some implementations, the E-SFN may be incremented by 1 every time the SFN wraps at a maximum value of the SFN.

Alternatively, in communicating, process 500 may involve processor 412 determining a subframe where a DRX ODT is started based on a DRX formula defined as:
if a short DRX cycle is used for a DRX group:

$$[ ( E - SFN \times 10240 ) + ( SFN \times 10 ) + subframe number ] modulo ( drx - ShortCycle ) = ( drx - StartOffset ) modulo ( drx - ShortCycle ) ,$$

if a long DRX cycle is used for a DRX group:

$$[ ( E - SFN \times 10240 ) + ( SFN \times 10 ) + subframe number ] modulo ( drx - LongCycle ) = drx - StartOffset ,$$

In the above DRX formulate, drx-ShortCycle may denote the short DRX cycle, drx-LongCycle may denote the long DRX cycle, drx-StartOffset may denote a DRX start offset, and SFN may denote an existing system frame number. In some implementations, in communicating, process 500 may further involve processor 412 communicating using the DRX formula with respect to a subset of DRX configurations. For instance, the subset of DRX configurations may include one or more DRX configurations in which a DRX cycle is not a factor of 10240 milliseconds. In some implementations, the E-SFN may be incremented by 1 every time the SFN wraps at a maximum value of the SFN.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
entering a discontinuous reception (DRX) mode in wireless communications; and
communicating with a network when in the DRX mode by using an extended system frame number (E-SFN) that wraps at a maximum value of the E-SFN and supports either or both of a non-integer DRX cycle and a non-integer periodicity of semi-persistent scheduling (SPS) or configured grant (CG).

2. The method of claim 1, wherein the communicating comprises receiving a value of the E-SFN in a system information block (SIB) broadcast by the network.

3. The method of claim 1, wherein the communicating comprises determining a subframe where a DRX on-duration timer (ODT) is started based on a DRX formula defined as:
if a short DRX cycle is used for a DRX group:
$$floor \{ n - [ drx - ShortCycle \times floor ( n / drx - ShortCycle ) ] \} = floor \{ drx - StartOffset - [ drx - ShortCycle \times floor ( drx - StartOffset / drx - ShortCycle ) ] \} ,$$
if a long DRX cycle is used for a DRX group:
$$floor \{ n - [ drx - LongCycle \times floor ( n / drx - LongCycle ) ] \} = drx - StartOffset ,$$
wherein n=(E-SFN×10240)+(SFN×10)+subframe number or n=(SFN×10)+subframe number,
wherein drx-ShortCycle denotes the short DRX cycle,
wherein drx-LongCycle denotes the long DRX cycle,
wherein drx-StartOffset denotes a DRX start offset, and
wherein SFN denotes an existing system frame number.

4. The method of claim 3, wherein the communicating further comprises communicating using the DRX formula with respect to a subset of DRX configurations.

5. The method of claim 4, wherein the subset of DRX configurations comprises one or more DRX configurations in which a DRX cycle is not a factor of 10240 milliseconds.

6. The method of claim 3, wherein the E-SFN is incremented by 1 every time the SFN wraps at a maximum value of the SFN.

7. The method of claim 1, wherein the communicating comprises determining a subframe where a DRX on-duration timer (ODT) is started based on a DRX formula defined as:
if a short DRX cycle is used for a DRX group:
$$[ ( E - SFN \times 10240 ) + ( SFN \times 10 ) + subframe number ] modulo ( drx - ShortCycle ) = ( drx - StartOffset ) modulo ( drx - ShortCycle ) ,$$
if a long DRX cycle is used for a DRX group:
$$[ ( E - SFN \times 10240 ) + ( SFN \times 10 ) + subframe number ] modulo ( drx - LongCycle ) = drx - StartOffset ,$$
wherein drx-ShortCycle denotes the short DRX cycle,
wherein drx-LongCycle denotes the long DRX cycle,
wherein drx-StartOffset denotes a DRX start offset, and
wherein SFN denotes an existing system frame number.

8. The method of claim 7, wherein the communicating further comprises communicating using the DRX formula with respect to a subset of DRX configurations.

9. The method of claim 8, wherein the subset of DRX configurations comprises one or more DRX configurations in which a DRX cycle is not a factor of 10240 milliseconds.

10. The method of claim 7, wherein the E-SFN is incremented by 1 every time the SFN wraps at a maximum value of the SFN.

11. An apparatus implementable in a user equipment (UE), comprising:
a transceiver configured to communicate wirelessly; and
a processor coupled to the transceiver and configured to perform, via the transceiver, operations comprising:
entering a discontinuous reception (DRX) mode in wireless communications; and
communicating, via the transceiver, with a network when in the DRX mode by using an extended system frame number (E-SFN) that wraps at a maximum value of the E-SFN and supports either or both of a non-integer DRX cycle and a non-integer periodicity of semi-persistent scheduling (SPS) or configured grant (CG).

12. The apparatus of claim 11, wherein the communicating comprises receiving a value of the E-SFN in a system information block (SIB) broadcast by the network.

13. The apparatus of claim 11, wherein the communicating comprises determining a subframe where a DRX on-duration timer (ODT) is started based on a DRX formula defined as:
if a short DRX cycle is used for a DRX group:
$$floor \{ n - [ drx - ShortCycle \times floor ( n / drx - ShortCycle ) ] \} = floor \{ drx - StartOffset - [ drx - ShortCycle \times floor ( drx - StartOffset / drx - ShortCycle ) ] \} ,$$
if a long DRX cycle is used for a DRX group:
$$floor \{ n - [ drx - LongCycle \times floor ( n / drx - LongCycle ) ] \} = drx - StartOffset ,$$
wherein n=(E-SFN×10240)+(SFN×10)+subframe number or n=(SFN×10)+subframe number,
wherein drx-ShortCycle denotes the short DRX cycle,
wherein drx-LongCycle denotes the long DRX cycle,
where drx-StartOffset denotes a DRX start offset, and
wherein SFN denotes an existing system frame number.

14. The apparatus of claim 13, wherein the communicating further comprises communicating using the DRX formula with respect to a subset of DRX configurations.

15. The apparatus of claim 14, wherein the subset of DRX configurations comprises one or more DRX configurations in which a DRX cycle is not a factor of 10240 milliseconds.

16. The apparatus of claim 13, wherein the E-SFN is incremented by 1 every time the SFN wraps at a maximum value of the SFN.

17. The apparatus of claim 11, wherein the communicating comprises determining a subframe where a DRX on-duration timer (ODT) is started based on a DRX formula defined as:
if a short DRX cycle is used for a DRX group:
$$[ ( E - SFN \times 10240 ) + ( SFN \times 10 ) + subframe number ] modulo ( drx - ShortCycle ) = ( drx - StartOffset ) modulo ( drx - ShortCycle ) ,$$
if a long DRX cycle is used for a DRX group:
$$[ ( E - SFN \times 10240 ) + ( SFN \times 10 ) + subframe number ] modulo ( drx - LongCycle ) = drx - StartOffset ,$$
wherein drx-ShortCycle denotes the short DRX cycle,
wherein drx-LongCycle denotes the long DRX cycle,
where drx-StartOffset denotes a DRX start offset, and
wherein SFN denotes an existing system frame number.

18. The apparatus of claim 17, wherein the communicating further comprises communicating using the DRX formula with respect to a subset of DRX configurations.

19. The apparatus of claim 18, wherein the subset of DRX configurations comprises one or more DRX configurations in which a DRX cycle is not a factor of 10240 milliseconds.

20. The apparatus of claim 17, wherein the E-SFN is incremented by 1 every time the SFN wraps at a maximum value of the SFN.
